(19) United States
(12) Patent Application Publication
(10) Pub. No.: US 2003/0112339 A1
(43) Pub. Date: Jun. 19, 2003

(54) Method and system for compositing images with compensation for light falloff

(75) Inventors: Nathan D. Cahill, West Henrietta, NY (US); Edward B. Gindele, Rochester, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/023,137

(22) Filed: Dec. 17, 2001

(51) Int. Cl. H04N 5/225

(52) U.S. Cl. 348/218.1

(57) ABSTRACT

A method for producing a composite digital image, includes the steps of: providing a plurality of partially overlapping source digital images having pixel values that are linearly or logarithmically related to scene intensity; modifying the source digital images by applying to one or more of the source digital images a radial exposure transform to compensate for exposure fall off as a function of the distance of a pixel from the center of the digital image to produce adjusted source digital images, and combining the adjusted source digital images to form a composite digital image

### FIELD OF THE INVENTION

The invention relates generally to the field of digital image processing, and in particular to a technique for compositing multiple images into a panoramic image comprising a large field of view of a scene.

### BACKGROUND OF THE INVENTION

Conventional methods of generating panoramic images comprising a wide field of view of a scene from a plurality of images generally include the following steps: (1) an image capture step, where the plurality of images of a scene are captured with overlapping pixel regions; (2) an image warping step, where the captured images are geometrically warped onto a cylinder, sphere, or any environment map; (3) an image registration step, where the warped images are aligned; and (4) a blending step, where the aligned warped images are blended together to form the panoramic image. For an example of an imaging system that generates panoramic images, see May et al. U.S. Ser. No. 09/224,547 filed Dec. 31, 1998.

In the image capture step, the captured images typically suffer from light falloff. As described in many texts on the subject of optics (for example, M. Klein, Optics, John Wiley & Sons, Inc., New York, 1986, pp. 193-256), lenses produce non-uniform exposure at the focal plane when imaging a uniformly illuminated surface. When the lens is modeled as a thin lens, the ratio of the intensity of the light of the image at a point is described as cos⁴ of the angle between the optical axis, the lens, and the point in the image plane. This cos⁴ falloff does not include such factors as vignetting, which is a property describing the loss of light rays passing through an optical system.

In photographic images, this cos⁴ falloff generally causes the comers of an image to be darker than desired. The effect of the falloff is more severe for cameras or capture devices with a short focal length lens. In addition, flash photography will often produce an effect similar to falloff if the subject is centrally located with respect to the image. This effect is referred to as flash falloff.

As described in U.S. Pat. No. 5,461,440 issued Oct. 24, 1995 to Toyoda et al., it is commonly known that light falloff may be corrected by applying an additive mask to an image in a log domain or a multiplicative mask to an image in the linear domain. This conventional cos⁴ based mask is solely dependent upon a single parameter: the focal length of the imaging system. Also, images with flash falloff in addition to lens falloff, may be compensated for by a stronger mask (i.e. a mask generated by using a smaller value for the focal length than one would normally use).

Gallagher et al. in U.S. Ser. No. 09/293,197 filed Apr. 16, 1999 describe a variety of methods of selecting the parameter used to generate the falloff compensation mask. For example, in this conventional teaching the parameter could be selected in order to simulate the level of falloff compensation that is naturally performed by the lens of the optical printer. Additionally, the parameter could be determined interactively by an operator using a graphical user interface (GUI), or the parameter could be dependent upon the film format (APS or SUC) or the sensor size. Finally, they teach a simple automatic method of determining the parameter.

Gallagher in U.S. Ser. No. 09/626,882 filed Jul. 27, 2000 describes a method of automatically determining a level of light falloff in an image. This method does not misinterpret image discontinuities as being caused by light falloff, as frequently happens in the other methods.

In panoramic imaging systems, any of the aforementioned methods of light falloff compensation could be used to compensate for the light falloff present in each source image. However, there would be a problem with using any of these methods directly. Since all of the current light falloff compensation methods are applicable to single images, any errors in the falloff compensation for each source image could be magnified when the composite image is formed.

Therefore, there exists a need in the art for a method of compensating for light falloff in multiple images that are intended to be combined into a composite image.

### SUMMARY OF THE INVENTION

The need is met according to the present invention by providing a method and system for producing a composite digital image that includes providing a plurality of partially overlapping source digital images having pixel values that are linearly or logarithmically related to scene intensity; modifying the source digital images by applying to one or more of the source digital images a radial exposure transform to compensate for exposure falloff as a function of the distance of a pixel from the center of the digital image to produce adjusted source digital images; and combining the adjusted source digital images to form a composite digital image.

### ADVANTAGES

The present invention has the advantage of simply and efficiently matching source digital images having light fall off characteristics such that the light falloff is compensated prior to the compositing step.

### BRIEF DESCRIPTION OF THE DRAWINGS

FIG. 1 is a block diagram illustrating a digital image processing system suitable for practicing the present invention;

FIG. 2 illustrates in block diagram form, the method of forming a composite image from at least two source images, at least one source image being compensated for light falloff;

FIG. 3 illustrates in block diagram form, one embodiment of the present invention;

FIGS. 4A and 4B illustrate the overlap regions between source images;

FIGS. 5A and 5B illustrate in block diagram form, the step of providing source digital images to the present invention;

FIG. 6 is a diagram of the relationship between the focal length, pixel position, and light falloff parameter in one of the source digital images;

FIG. 7 is a diagram of the relationship between the focal length, pixel position, and light falloff parameter in two of the source digital images;

FIG. 8 is a diagram of the process of modifying the source digital image to compensate for light falloff;

FIG. 9 is a plot of the pixel values in the overlap region of the second source digital versus the pixel values of the overlap region of the first source digital image;

FIG. 10 is a plot of the pixel values in the overlap region of the second source digital image versus the pixel values of the overlap region of the first source digital image;

FIG. 11 is a diagram of the process of combining images to form a composite image;

FIG. 12 illustrates in block diagram form, an embodiment of the present invention further including the step of transforming the composite image into an output device compatible color space; and

FIGS. 13A and 13B are diagrams of image data and metadata contained in a source image file.

### DETAILED DESCRIPTION OF THE INVENTION

The present invention will be described as implemented in a programmed digital computer. It will be understood that a person of ordinary skill in the art of digital image processing and software programming will be able to program a computer to practice the invention from the description given below. The present invention may be embodied in a computer program product having a computer readable storage medium such as a magnetic or optical storage medium bearing machine readable computer code. Alternatively, it will be understood that the present invention may be implemented in hardware or firmware.

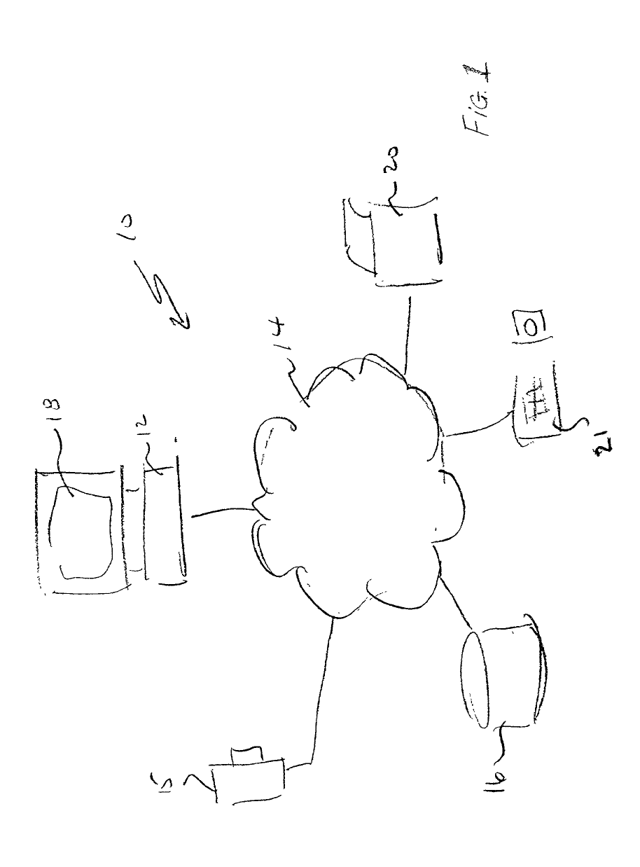

Referring first to FIG. 1, a digital image processing system useful for practicing the present invention is shown. The system generally designated 10, includes a digital image processing computer 12 connected to a network 14. The digital image processing computer 12 can be, for example, a Sun Sparcstation, and the network 14 can be, for example, a local area network with sufficient capacity to handle large digital images. The system includes an image capture device 15, such as a high resolution digital camera, or a conventional film camera and a film digitizer, for supplying digital images to network 14. A digital image store 16, such as a magnetic or optical multi-disk memory, connected to network 14 is provided for storing the digital images to be processed by computer 12 according to the present invention. The system 10 also includes one or more display devices, such as a high resolution color monitor 18, or hard copy output printer 20 such as a thermal or inkjet printer. An operator input, such as a keyboard and track ball 21, may be provided on the system.

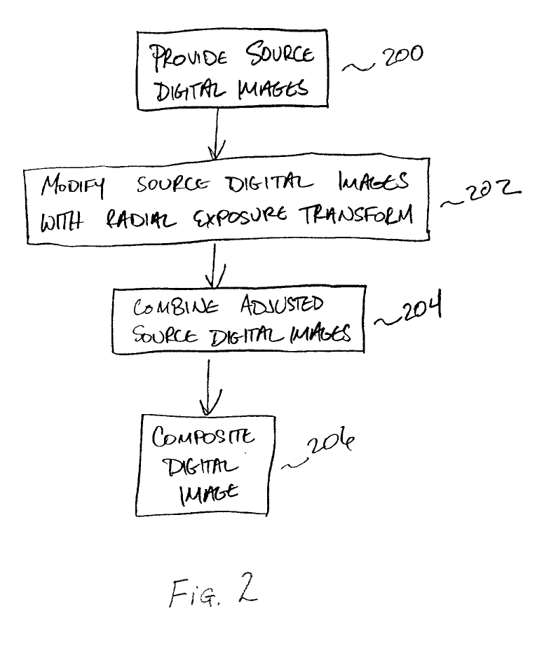

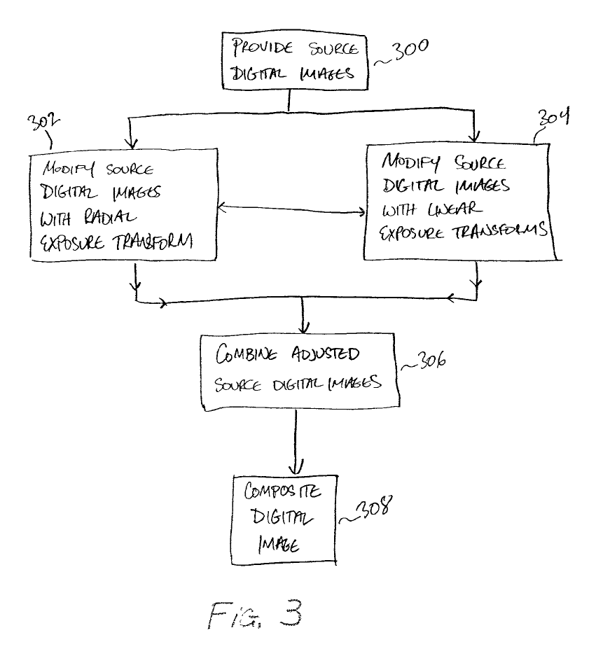

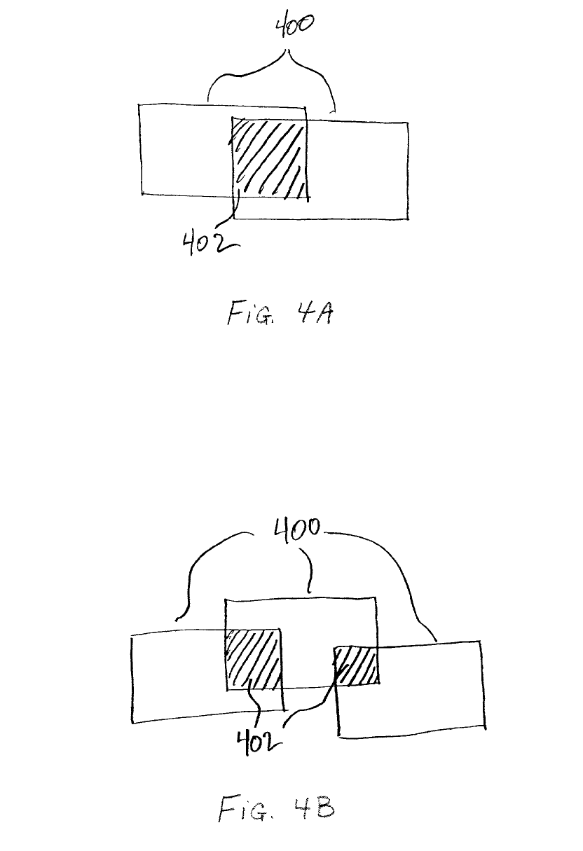

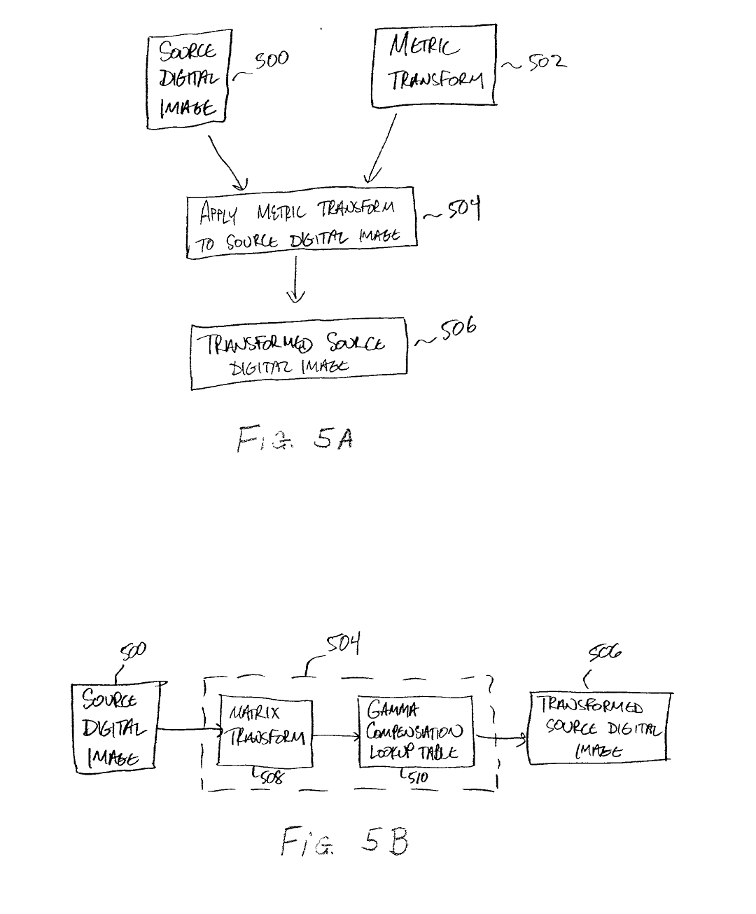

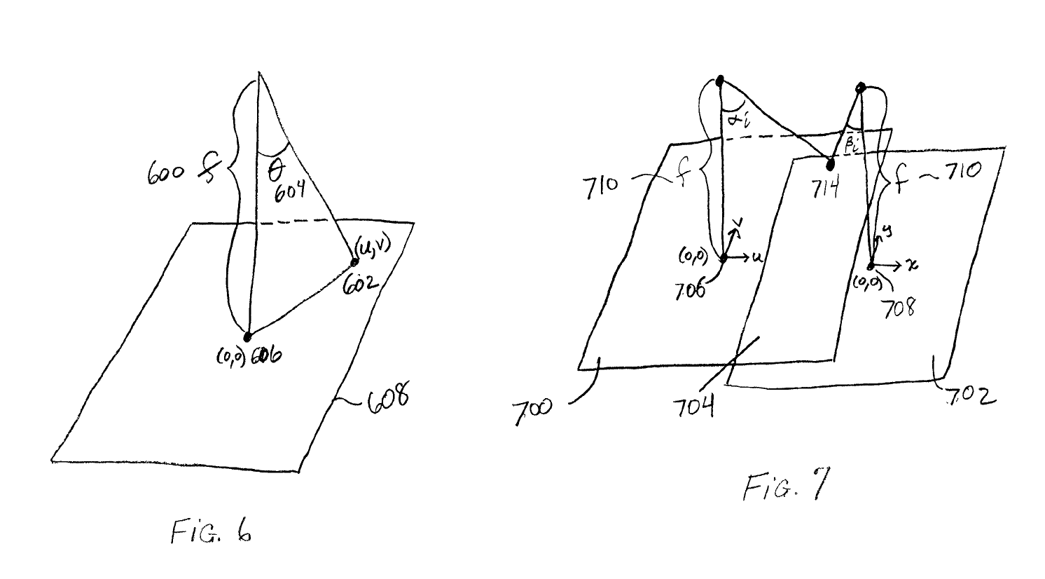

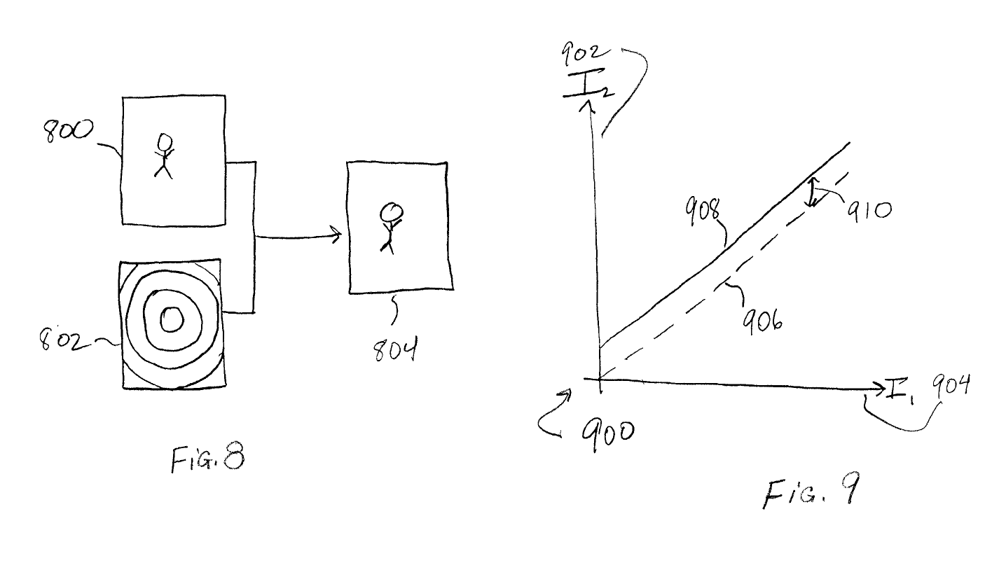

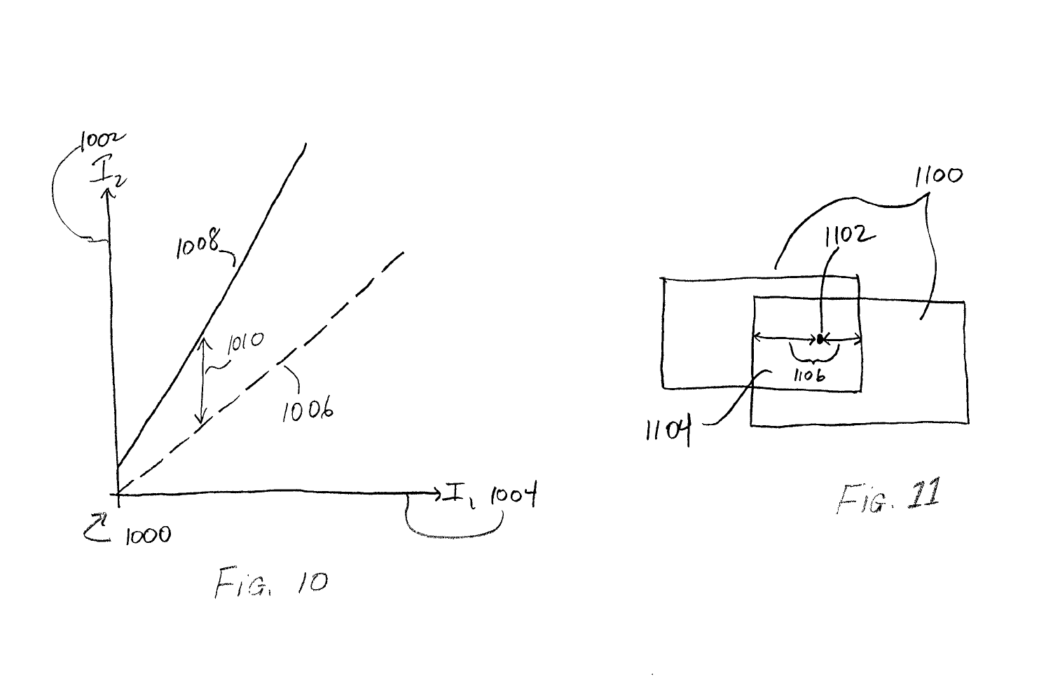

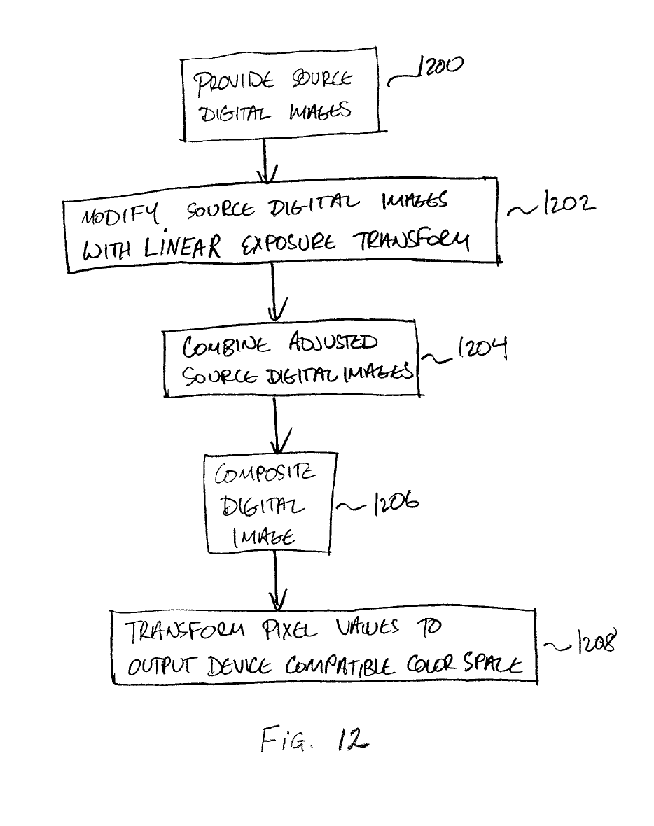

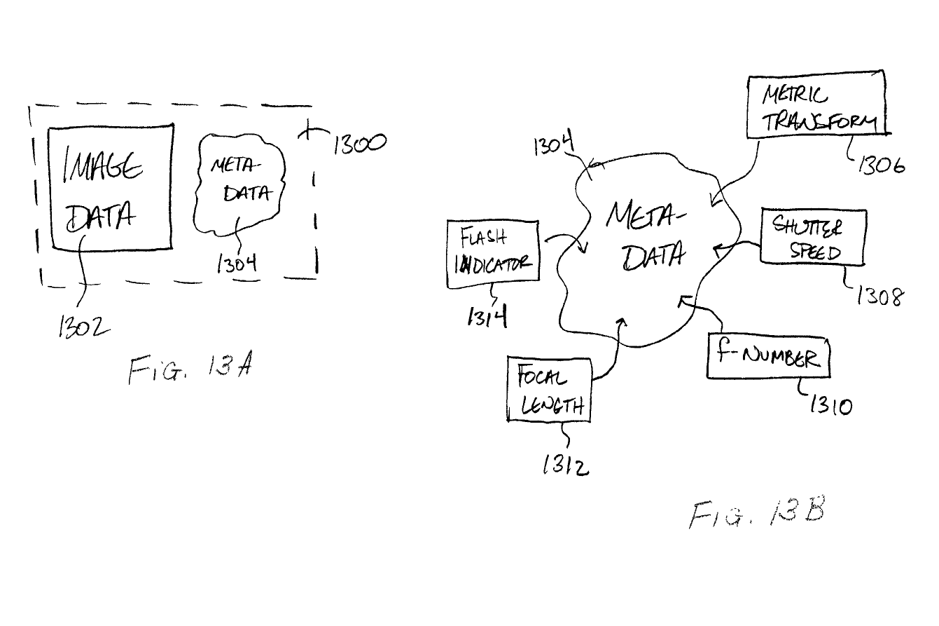

Referring next to FIG. 2, at least two overlapping source digital images are provided 200 to the processing system 10. The source digital images can be provided by a variety of means; for example, they can be captured from a digital camera, extracted from frames of a video sequence, scanned from hardcopy output, or generated by any other means. The pixel values of at least one of the source digital images are modified 202 by a radial exposure transform so that any light falloff present in the source digital images is compensated, yielding a set of adjusted source digital images. A radial exposure transform refers to a transformation that is applied to the pixel values of a source digital image, the transformation being a function of the distance from the pixel to the center of the image. The adjusted source digital images are then combined 204 by a feathering scheme, weighted averages, or some other blending technique known in the art, to form a composite digital image 206.

Referring next to FIG. 3, according to an alternative embodiment of the present invention, at least two overlapping source digital images are provided 300 to the processing system 10. The pixel values of at least one of the source digital images are modified 302 by a radial exposure transform so that any light falloff present in the source digital images is compensated. In addition, the pixel values of at least one of the source digital images are modified 304 by a linear exposure transform so that the pixel values in the overlap regions of overlapping source digital images are similar. A linear exposure transform refers to a transformation that is applied to the pixel values of a source digital image, the transformation being linear with respect to the scene intensity values at each pixel. The radial exposure transform and the linear exposure transform can be applied to the same source digital image, or to different source digital images. Also, the modification steps 302 and 304 can be applied in any order. Once either or both of the modification steps are completed, they yield adjusted source digital images. The adjusted source digital images are then combined 306 by a feathering scheme, weighted averages, or some other blending technique known in the art, to form a composite digital image 308.

Referring next to FIGS. 4A and 4B, the at least two source digital images 400 overlap in overlapping pixel regions 402.

Referring next to FIG. 5A, according to a further embodiment of the present invention, the step 200 of providing at least two source digital images further comprises the step 504 of applying a metric transform 502 to a source digital image 500 to yield a transformed source digital image 506. A metric transform refers to a transformation that is applied to the pixel values of a source digital image, the transformation yielding transformed pixel values that are linearly or logarithmically related to scene intensity values. In instances where metric transforms are independent of the particular content of the scene, they are referred to as scene independent transforms.

Referring next to FIG. 5B, in one embodiment, the step of applying the metric transform 504 includes applying a matrix transformation 508 and a gamma compensation lookup table 510. In one example of such an embodiment, a source digital image 500 was provided from a digital camera, and contains pixel values in the sRGB color space. A metric transform 502 is used to convert the pixel values into nonlinearly encoded Extended Reference Input Medium Metric (ERIMM) (PIMA standard #7466, found on the World Wide Web at http://www.pima.net/standards/it10/IT10 POW.htm), so that the pixel values are logarithmically related to scene intensity values.

Referring next to FIG. 6, we illustrate the relationship between the focal length ƒ600, pixel position (u,v) 602, and light falloff parameter θ604 in one of the source digital images 608. If the origin 606 is located at the center of the source digital image 608, and if a uniformly illuminated surface parallel to the image plane is imaged through a thin lens, then the exposure I(u, v) received at pixel position (u,v) is given by:

I(u,v)=I(0,0)cos⁴(tan⁻¹θ),

$$θ = \frac{\sqrt{{u}^{2} + {v}^{2}}}{f} ,$$

where I(0,0) is the exposure falling on the center of the source digital image 608, and the focal length ƒ600 is measured in terms of pixels.

Referring next to FIG. 7, we illustrate two source digital images 700 and 702 that overlap in an overlapping pixel region 704. The center 706 of source digital image 700 is located at the image center, and its local coordinate system is defined by positions (u,v). The center 708 of source digital image 702 is located at the image center, and its local coordinate system is defined by positions (x,y). The focal length used in the capture of source digital images 700 and 702 is given by ƒ710 (in pixels). Consider a point 714 located in the overlapping pixel region 704. If the coordinates of point 714 are given by (uᵢ,vᵢ) in image 700, and by (xᵢ, yᵢ) in image 702, and if a uniformly illuminated surface parallel to the image plane is imaged through a thin lens during both the captures of source digital image 700 and source digital image 702, then the exposure I(uᵢ,vᵢ) received at point 714 in source digital image 700 is given by:

I(uᵢ,vᵢ)=I₁(0,0)cos⁴(tan⁻¹αᵢ),

$${α}_{i} = \frac{\sqrt{{u}_{i}^{2} + {v}_{i}^{2}}}{f} ,$$

where I₁(0,0) is the exposure falling on the center of the source digital image 700. The exposure I(xᵢ,yᵢ) received at point 714 in source digital image 702 is given by:

I(xᵢ,yᵢ)=I₂(0,0)cos⁴(tan⁻¹βᵢ),

$${β}_{i} = \frac{\sqrt{{x}_{i}^{2} + {y}_{i}^{2}}}{f} ,$$

where I₂(0,0) is the exposure falling on the center of the source digital image 702.

The point 714 in the overlapping pixel region 704 when considered as a point in the source digital image 700, corresponds to the same scene content as if it were considered a point in the source digital image 702. Therefore, if the overall exposure level of each source digital image 700 and 702 is the same, then the light falloff can automatically be determined without the knowledge of the focal length. (Note that if the focal length is known, the amount of light falloff is readily determined by the aforementioned formula). Consider that the exposure value recorded at point 714 in source digital image 700 is Iᵢ′, and the exposure value recorded at point 714 in source digital image 702 is Iᵢ″. Then, the following relation must hold:

$$\frac{{I}_{i}^{″}}{{cos}^{4} ( {tan}^{- 1} ( {f}^{- 1} \sqrt{{x}_{i}^{2} + {y}_{i}^{2}} ) )} = \frac{{I}_{i}^{′}}{{cos}^{4} ( {tan}^{- 1} ( {f}^{- 1} \sqrt{{u}_{i}^{2} + {v}_{i}^{2}} ) )} .$$

Since Iᵢ″, Iᵢ″, uᵢ, vᵢ, xᵢ, and yᵢ are known, the focal length ƒ710 can be found by identifying the root of the function:

g(f)=Iᵢ″ cos⁴(tan⁻¹(f⁻¹\sqrt{uᵢ²+vᵢ²}))−Iᵢ″cos⁴(tan⁻¹(f⁻¹\sqrt{xᵢ²+yᵢ²})).

This root can be approximated by an iterative process, such as Newton's method; see J. Stewart, “Calculus”, 2^{nd} Ed., Brooks/Cole Publishing Company, 1991, p. 170. Once the focal length ƒ710 has been found, we know enough information to compensate for light falloff without having to identify the falloff parameter as described in one of the aforementioned light falloff compensation techniques.

Even though the focal length can be estimated from the pixel values of a single point 714 in the overlapping pixel region 704 of the source digital images 700 and 702, multiple points in the overlapping pixel region can be used to provide a more robust estimate. Consider n points in the overlapping pixel region 704, where n>1. Let these points have coordinates (uᵢ,vᵢ), i=1 . . . n in source digital image 700, and coordinates (xᵢ,yᵢ), i=1. . . n in source digital image 702. Consider that the exposure value recorded at the i^{th} point in source digital image 700 is Iᵢ′, and the exposure value recorded at the i^{th} point in source digital image 702 is Iᵢ″. Now, the aforementioned relation must hold for each point in the overlapping pixel region 704. Therefore, the focal length ƒ710 can be found by minimizing some error measure. A typical error measure is sum of squared errors (SSE). Using SSE, the following function would be minimized:

$$r ( f ) = {\sum }_{i = 1}^{n} {[ {I}_{i}^{″} {cos}^{4} ( {tan}^{- 1} ( {f}^{- 1} \sqrt{{u}_{i}^{2} + {v}_{i}^{2}} ) ) - {I}_{i}^{′} {cos}^{4} ( {tan}^{- 1} ( {f}^{- 1} \sqrt{{x}_{i}^{2} + {y}_{i}^{2}} ) ) ]}^{2} .$$

The minimum of r(ƒ) can be found by one of a variety of different techniques; for example, nonlinear least squares techniques such as the Levenberg-Marquardt methods (Fletcher, “Practical Methods of Optimization”, 2^{nd} Ed., John Wiley & Sons, 1987, pp. 100-119), or line search algorithms (Fletcher, pp. 33-40).

All of the aforementioned formulas and equations can be applied when the image pixel values are proportional to the exposure values falling onto the image planes. If image pixel values are proportional to the logarithm of the exposure values (as is the case if the image pixel values are encoded in the nonlinear encoding of ERIMM), then all of the aforementioned formulas must be modified to replace cos⁴ (•) with 4 log(cos(•)), where • indicates the argument of the cosine function.

In some instances, the overall exposure level of each source digital image 700 and 702 can differ. In these cases, the light falloff and the factor describing the overall difference in exposure levels can be simultaneously determined automatically without the knowledge of the focal length; however, two distinct points in the overlapping pixel region 704 are required. Copending U.S. Ser. No. ______ (EK Docket 83516/THC) filed by Cahill et al. Nov. 5, 2001, details a technique for automatically determining the factor describing overall difference in exposure levels between multiple images, but that technique may not be robust if there is any significant falloff on at least one of the source images. Consider that the exposure value recorded at the i^{th} point in the overlapping pixel region of source digital image 700 is Iᵢ′, and the exposure value recorded at the corresponding point of source digital image 702 is Iᵢ″, and that i≧2. Then, the following relation must hold:

$$\frac{{I}_{i}^{″}}{{cos}^{4} ( {tan}^{- 1} ( {f}^{- 1} \sqrt{{x}_{i}^{2} + {y}_{i}^{2}} ) )} = \frac{h {I}_{i}^{′}}{{cos}^{4} ( {tan}^{- 1} ( {f}^{- 1} \sqrt{{u}_{i}^{2} + {v}_{i}^{2}} ) )} ,$$

for i=1 . . . n, where h is the factor describing the overall difference in exposure levels. Since Iᵢ′, Iᵢ″, uᵢ, vᵢ, xᵢ, and yᵢ are known, the focal length f and the exposure factor h can be found by minimizing some error measure. A typical error measure is sum of squared errors (SSE). Using SSE, the following function would be minimized:

$$r ( f , h ) = {\sum }_{i = 1}^{n} {[ {I}_{i}^{″} {cos}^{4} ( {tan}^{- 1} ( {f}^{- 1} \sqrt{{u}_{i}^{2} + {v}_{i}^{2}} ) ) - h {I}_{i}^{′} {cos}^{4} ( {tan}^{- 1} ( {f}^{- 1} \sqrt{{x}_{i}^{2} + {y}_{i}^{2}} ) ) ]}^{2} .$$

The minimum of r(f, h) can be found by one of a variety of different nonlinear least squares techniques, for example, the aforementioned Levenberg-Marquardt methods.

As in the case where the overall exposure characteristics of the source images are the same, if the image pixel values are not proportional to exposure values, but rather to the logarithm of the exposure values, the above relation becomes:

Iᵢ″−4 log(cos(tan⁻¹(f⁻¹\sqrt{xᵢ²+yᵢ²})))=h+Iᵢ^{′}−4 log(cos(tan⁻¹(f⁻¹\sqrt{uᵢ²+vᵢ²}))),

and the corresponding function to minimize is:

$$\begin{matrix}r ( f , h ) = {\sum }_{i = 1}^{n} [ {I}_{i}^{″} - {I}_{i}^{′} - h + 4 log ( cos ( {tan}^{- 1} ( {f}^{- 1} \sqrt{{u}_{i}^{2} + {v}_{i}^{2}} ) ) ) - \\ { 4 log ( cos ( {tan}^{- 1} ( {f}^{- 1} \sqrt{{x}_{i}^{2} + {y}_{i}^{2}} ) ) ) ]}^{2}\end{matrix}$$

Referring next to FIG. 8, the process of modifying the source digital image 800 to compensate for light falloff is illustrated. A light falloff compensation mask 802 is generated and applied to the source digital image to form the adjusted source digital image 804. The compensation mask 802 can either be added to or multiplied by the source image 800 to form the adjusted source digital image 804. If the source image pixel values are proportional to exposure values, the value of the mask at pixel position (u,v) (with (0,0) being the center of the mask) is given by:

mask(u,v)=[cos⁴(tan⁻¹(f⁻¹\sqrt{u²+v²}))]⁻¹,

and the mask 802 is multiplied with the source digital image 800 to form the adjusted source digital image 804. If the source digital image pixel values are proportional to the logarithm of the exposure values, the value of the mask at pixel position (u, v) (with (0,0) being the center of the mask) is given by:

mask(u, v)=−4 log(cos⁴(tan⁻¹(f⁻¹\sqrt{u²+v²}))),

and the mask 802 is added to the source digital image 800 to form the adjusted source digital image 804.

Referring next to FIG. 9, we show a plot 900 of the pixel values in the overlap region of the second source digital 902 versus the pixel values of the overlap region of the first source digital image 904. If the pixel values in the overlap regions are identical, the resulting plot would yield the identity line 906. In the case that the difference between the pixel values of the two images is a constant, the resulting plot would yield the line 908, which differs at each value by a constant amount 910. The step 304 of modifying at least one of the source digital images by a linear exposure transform would then comprise applying the constant amount 910 to each pixel in the first source digital image. One example of when a linear exposure transform would be constant is when the pixel values of the source digital images are in the nonlinearly encoded Extended Reference Input Medium Metric. The constant coefficient of the linear exposure transform can be estimated by a linear least squares technique (see Lawson et al., Solving Least Squares Problems, SIAM, 1995, pp. 107-133) that minimizes the error between the pixel values in the overlap region of the second source digital image and the transformed pixel values in the overlap region of the first source digital image.

In another embodiment, the linear exposure transforms are not estimated, but rather computed directly from the shutter speed and F-number of the lens aperture. If the shutter speed and F-number of the lens aperture are known (for example, if they are stored in meta-data associated with the source digital image at the time of capture), they can be used to estimate the constant offset between source digital images whose pixel values are related to the original log exposure values. If the shutter speed (in seconds) and F-number of the lens aperture for the first image are T₁ and F₁ respectively, and the shutter speed (in seconds) and F-number of the lens aperture for the second image are T₂ and F₂ respectively, then the constant offset between the log exposure values is given by:

log₂(F₂²)+log₂(T₂)−log₂(F₁²)−log₂(T₁),

and this constant offset can be added to the pixel values in the first source digital image.

Referring next to FIG. 10, we show a plot 1000 of the pixel values in the overlap region of the second source digital 1002 versus the pixel values of the overlap region of the first source digital image 1004. If the pixel values in the overlap regions are identical, the resulting plot would yield the identity line 1006. In the case that the difference between the two images is a linear transformation, the resulting plot would yield the line 1008, which differs at each value by an amount 1010 that varies linearly with the pixel value of the first source digital image. The step 304 of modifying at least one of the source digital images by a linear exposure transform would then comprise applying the varying amount 1010 to each pixel in the first source digital image. One example of when a linear exposure transform would contain a nontrivial linear term is when the pixel values of the source digital images are in the Extended Reference Input Medium Metric. The linear and constant coefficients of the linear exposure transform can be estimated by a linear least squares technique as described above with reference to FIG. 9.

Referring next to FIG. 11, the adjusted source digital images 1100 are combined in the overlap region 1104 by a feathering scheme, weighted averages, or some other blending technique known in the art, to form a composite digital image 1106. In one embodiment, a pixel 1102 in the overlap region 1104 is assigned a value based on a weighted average of the pixel values from both adjusted source digital images 1100; the weights are based on its composite digital image 1106 to the edges of the adjusted source digital images 1100.

Referring next to FIG. 12, according to a further embodiment of the present invention, at least two source digital images are provided 1200 to the processing system 10. The pixel values of at least one of the source digital images are modified 1202 by a radial exposure transform so that any light falloff present in the source digital images is compensated, yielding a set of adjusted source digital images. The adjusted source digital images are then combined 1204 by a feathering scheme, weighted averages, or some other blending technique known in the art, to form a composite digital image 1206. The pixel values of the composite digital image are then converted into an output device compatible color space 1208. The output device compatible color space can be chosen for any of a variety of output scenarios; for example, video display, photographic print, ink-jet print, or any other output device.

Referring finally to FIGS. 13A and 13B, at least one of the source digital image files 1300 may contain meta-data 1304 in addition to the image data 1302. Such meta-data 1304 could include the metric transform 1306, the shutter speed 1308 at which the image was captured, the f-number 1310 of the aperture when the image was captured, the focal length 1312 when the image was captured, a flash indicator 1314 to indicate the use of the flash when the image was captured, or any other information pertinent to the pedigree of the source digital image. The meta-data can be used to directly compute the linear transformations as described above.

The invention has been described in detail with particular reference to certain preferred embodiments thereof, but it will be understood that variations and modifications can be effected within the spirit and scope of the invention.

### PARTS LIST

10 digital image processing system

12 digital image processing computer

14 network

15 image capture device

16 digital image store

18 high resolution color monitor

20 hard copy output printer

21 keyboard and trackball

200 provide source digital images step

202 modify source digital images step

204 combine adjusted source digital images step

206 composite digital image

300 provide source digital images step

302 modify source digital images with radial exposure transform step

304 modify source digital images with linear exposure transform step

306 combine adjusted source digital images step

308 composite digital image

400 source digital images

402 overlap regions

500 source digital image

502 metric transform

504 apply metric transform step

506 transformed source digital image

508 matrix transform

510 gamma compensation lookup table

600 focal length ƒ

602 point (u,v)

604 angle θ

606 image center

608 source digital image

700 source digital image

702 source digital image

704 overlapping pixel region

706 image center

708 image center

710 focal length ƒ

714 point

800 source digital image

802 light falloff compensation mask

804 adjusted source digital image

900 plot of relationship between pixel values of overlap region

902 second image values

904 first image values

906 identity line

908 actual line

910 constant offset

1000 plot of relationship between pixel values of overlap region

1002 second image values

1004 first image values

1006 identity line

1008 actual line

1010 linear offset

1100 adjusted source digital images

1102 pixel

1104 overlap region

1106 composite digital image

1200 provide source digital images step

1202 modify source digital images step

1204 combine adjusted source digital images step

1206 composite digital image

1208 transform pixel values step

1300 source digital image file

1302 image data

1304 meta-data

1306 metric transform

1308 shutter speed

1310 f-number

1312 focal length

1314 flash indicator

What is claimed is:

1. A method for producing a composite digital image, comprising the steps of:
a) providing a plurality of partially overlapping source digital images having pixel values that are linearly or logarithmically related to scene intensity;
b) modifying the source digital images by applying to one or more of the source digital images a radial exposure transform to compensate for exposure fall off as a function of the distance of a pixel from the center of the digital image to produce adjusted source digital images; and
c) combining the adjusted source digital images to form a composite digital image.

2. The method of claim 1, further comprising the step of applying a linear exposure transform to one or more of the source digital images prior to combining the adjusted source digital images to produce adjusted source digital images having pixel values that closely match in an overlapping region.

3. The method claimed in claim 1, wherein the radial exposure transform includes a cos⁴ dependence on the distance from the center of the image.

4. The method claimed in claim 1, wherein the step of providing source digital images further comprises the step of applying a metric transform to a source digital image such that the pixel values of the transformed source digital image are linearly or logarithmically related to scene intensity.

5. The method claimed in claim 4, wherein the metric transform is a scene independent transform.

6. The method of claim 1, wherein the combining step includes calculating a weighted average of the pixel values in the overlapping region.

7. The method of claim 1, further comprising the step of transforming the pixel values of the composite digital image to an output device compatible color space.

8. The method of claim 4, wherein the metric transform includes a color transformation matrix.

9. The method of claim 4, wherein the metric transform includes a lookup table.

10. The method of claim 4, wherein the metric transform is included as metadata with the corresponding source digital image.

11. The method of claim 2, wherein the linear exposure transform is a function of the shutter speed used to capture the source digital image, and the shutter speed is included as meta-data with the corresponding source digital image.

12. The method of claim 2, wherein the linear exposure transform is a function of the f-number used to capture the source digital image and the f-number is included as meta-data with the corresponding source digital image.

13. The method of claim 1, wherein the radial transform is included as metadata with the corresponding source digital image.

14. The method claimed in claim 1, wherein the focal length of the lens used to capture each source digital image is employed to calculate the radial transform.

15. The method claimed in claim 1, wherein a use of flash indicator is employed to calculate the radial transform for each digital image.

16. A system for producing a composite digital image, comprising:
a) providing a plurality of partially overlapping source digital images having pixel values that are linearly or logarithmically related to scene intensity;
b) modifying the source digital images by applying to one or more of the source digital images a radial exposure transform to compensate for exposure fall off as a function of the distance of a pixel from the center of the digital image to produce adjusted source digital images; and
c) combining the adjusted source digital images to form a composite digital image.

17. A computer program product for performing the method of claim 1.
